(19) United States
(12) Patent Application Publication
(10) Pub. No.: US 2017/0338060 A1
(43) Pub. Date: Nov. 23, 2017

(54) ELECTROLYTIC COMPOSITIONS FOR ELECTRIC ENERGY STORAGE AND GENERATION DEVICES

(71) Applicant: SACHEM, Inc., Austin, TX (US)

(72) Inventors: Paul VERMEULEN, Eindhoven (NL); Craig ALLEN, Austin, TX (US); Charles B. LITTLE, Austin, TX (US)

(21) Appl. No.: 15/523,681

(22) PCT Filed: Nov. 3, 2015
(86) PCT No.: PCT/US2015/058757

§ 371 Date: May 2, 2017

Related U.S. Application Data
(60) Provisional application No. 62/074,190, filed on Nov. 3, 2014.

(51) Int. Cl. H01G 11/62; H01G 11/60

(52) U.S. Cl. CPC H01G 11/62; H01G 11/60

(57) ABSTRACT

In one embodiment, the present invention relates to an electric device, comprising an electrolyte comprising a solvent; a first quaternary ammonium or phosphonium salt; and a second quaternary ammonium or phosphonium salt, containing an ammonium group having a general formula [NR¹R²R³R⁴]⁺, or a phosphonium group having a general formula [PR¹R²R³R⁴]⁺, wherein R¹═R², R³═R⁴, R²≠R³, and each R¹, R², R³ and R⁴ independently is a branched or unbranched alkyl group containing from 1 to about 20 carbon atoms, and in which each salt comprises an anion, and wherein the first and second ammonium or phosphonium are not the same. In another embodiment, the present invention relates to the electrolyte.

### TECHNICAL FIELD

The present invention relates to electrolytic compositions for energy storage and generation devices, such as capacitors, some of which are variously referred to as supercapacitors, electrochemical capacitors, electrolytic capacitors, batteries, fuel cells, sensors, electrochromic devices, photoelectrochemical solar cells, light-emitting electrochemical cells, polymer light emitting diodes (PLEDs) and polymer light-emitting electrochemical cells (PLECs), electrophoretic displays, and more particularly to an electrolytic compositions for electric double-layer capacitors (ELDC), which are members of the family of electrochemical capacitors. The present invention further relates to the use of the new electrolytic compositions in magnesium and/or lithium ion batteries as well as in the energy storage and generation devices mentioned above.

### BACKGROUND

Increasing the amount of energy stored energy storage devices, such as an electric double layer capacitor (EDLC), can be achieved by increasing the capacitance and the maximum operating voltage. From these two, increasing the maximum operating voltage is the most effective as the amount of energy stored increases with the square of the maximum operating voltage. The voltage window is typically limited by the stability of the salts in the electrolyte. The maximum operating voltage of an EDLC is limited by the voltage where the salt in the electrolyte starts to decompose via redox reactions. The decomposition of the electrolyte limits both the amount of energy stored in the EDLC and the lifetime of the ELDC. To avoid any shortening of the lifetime, the maximum operating voltage of an EDLC is typically 2.5 volts (V).

It would be desirable to obtain, in response to the demand in the industry, improved energy storage and generation devices, including capacitors, supercapacitors, electric double-layer capacitors (ELDC), batteries, fuel cells, sensors, electrochromic devices, photoelectrochemical solar cells, light-emitting electrochemical cells, polymer light emitting diodes (PLEDs), polymer light-emitting electrochemical cells (PLECs), lithium ion batteries and electrolytic capacitors, so that these devices can provide increased voltage and power. In particular, it would be desirable to obtain an increase in the operating voltage of ELDCs.

### SUMMARY

The present invention provides electrolytes that allow the maximum voltage of electrical storage devices, such as capacitors and supercapacitors, batteries, fuel cells, and particularly of ELDCs, to be significantly increased, e.g., from the conventional ELDC voltage of 2.5 V to at least 3.0 V. The present invention provides, in various embodiments, electrolytes for use in energy storage and generation devices, including capacitors, supercapacitors, electric double-layer capacitors (ELDC), batteries, fuel cells, sensors, electrochromic devices, photoelectrochemical solar cells, light-emitting electrochemical cells, polymer light emitting diodes (PLEDs), polymer light-emitting electrochemical cells (PLECs), lithium ion batteries and electrolytic capacitors, so that these devices can provide increased voltage and power.

Thus, in one embodiment, the present invention relates to electric device, comprising an electrolyte comprising:

a solvent;

a first quaternary ammonium or phosphonium salt; and

a second quaternary ammonium or phosphonium salt, containing an ammonium group having a general formula [NR¹R²R³R⁴]⁺, or a phosphonium group having a general formula [PR¹R²R³R⁴]⁺, wherein R¹═R², R³═R⁴, R²≠R³, and each R¹, R², R³ and R⁴ independently is a branched or unbranched alkyl group containing from 1 to about 20 carbon atoms, and

in which each salt comprises an anion, and in which the first and second ammonium or phosphonium are not the same.

In one embodiment, the electric device is a energy storage and generation device, such as a capacitor, supercapacitor, electrochemical capacitor, electrolytic capacitor, battery, fuel cell, sensor, electrochromic device, photoelectrochemical solar cell, light-emitting electrochemical cell, polymer light emitting diode (PLED) and polymer light-emitting electrochemical cell (PLEC), and, particularly, an electric double-layer capacitor (ELDC), which capacitor is a member of the family of supercapacitors. The present invention further relates to use of the new electrolytic compositions in magnesium and/or lithium ion batteries, as well as in the energy storage and generation devices mentioned above.

In one embodiment, the electric device is an electric double layer capacitor.

In another embodiment, the present invention relates to electrolyte comprising:

a solvent;

a first quaternary ammonium or phosphonium salt; and

a second quaternary ammonium or phosphonium salt, containing an ammonium group having a general formula [NR¹R²R³R⁴]⁺, or a phosphonium group having a general formula [PR¹R²R³R⁴]⁺, wherein R¹═R², R³═R⁴, R²≠R³, and each R¹, R², R³ and R⁴ independently is a branched or unbranched alkyl group containing from 1 to about 20 carbon atoms, and

wherein each salt comprises an anion, and wherein the first and second ammonium or phosphonium are not the same.

In one embodiment, the first quaternary ammonium or phosphonium salt contains an ammonium group having a general formula [NR⁵(R⁶)₃]⁺, or a phosphonium group having a general formula [PR⁵(R⁶)₃]⁺, wherein R⁵≠R⁶, and each R⁵ and R⁶ independently is a branched or unbranched alkyl group containing from 1 to about 20 carbon atoms.

In one embodiment, the anion comprises one or more of BF₄⁻, PF₆⁻, AsF₆⁻, SbF₆⁻, BARF, BOB, FOB, BSB, tetrakis(pentafluorophenyl)borate (B(C₆F₅)₄⁻), Al(OC(CF₃)₃)₄⁻, maleate, phthalate, ClO₄⁻, trifluoromethanesulfonate and alkyl trifluoromethanesulfonate.

In one embodiment, the ammonium or phosphonium ion of the second quaternary ammonium or phosphonium salt is one or a combination of any two or more of dimethyldiethyl, dimethyldipropyl, dimethyldibutyl, dimethyldipentyl, dimethyldihexyl, diethyldipropyl, diethyldibutyl, diethyldipentyl and diethyldihexyl ammonium or phosphonium.

In one embodiment, the solvent is selected from propylene carbonate, dimethylsulfoxide, N, N dimethylformamide, ethylene carbonate, dimethyl carbonate, diethyl carbonate, acetonitrile, sulfolane and y-butyrolactone. In one embodiment, the first quaternary ammonium salt is methyltriethyl ammonium BF4 (MTEABF4) and the second quaternary ammonium salt is dimethyldipropyl ammonium BF4 (DMDPABF4).

In one embodiment, the DMDPABF4 is at a concentration in the range from about 0.5 M to about 1.0 M, and the MTEABF4 is at a concentration in the range from about 1 M to about 2 M, or the DMDPABF4 is at a concentration in the range from about 0.65 M to about 0.85 M, and the MTEABF4 is at a concentration in the range from about 1.25 M to about 1.75 M, or the DMDPABF4 is at a concentration of about 0.75 M, and the MTEABF4 is at a concentration of about 1.5 M.

The unexpected benefits of the present invention include one or more of the following:

Higher solubility of the salts, such as DMDPABF4, in acetonitrile compared to MTEABF4;

Higher operating voltage at high BF4 salt concentrations;

Higher operating voltage observed for the combination of salts, such as the combination of MTEABF4 and DMDPABF4, whereas at the same concentrations of the single salts, i.e., each salt alone, no higher operating voltage is found; and

Higher energy storage is observed for the combination of salts such as MTEABF4 and DMDPABF4.

The foregoing benefits provide the possibility to build higher power ELDCs.

### BRIEF DESCRIPTION OF THE DRAWINGS

FIG. 1 is a schematic cross-section of an electric double layer capacitor used to assess the maximum operating voltage provided by an electrolyte in accordance with an embodiment of the present invention.

FIG. 2 is a graph of the ionic conductivity of MTEA.BF4 and DMDPA.BF4 in acetonitrile as a function of concentration at room temperature.

FIG. 3 depicts a series of voltammograms of an EDLC filled with 1.5 M MTEA.BF4 of scans between 0 and 2.0, 2.5, 3.0 and 3.5 V, measured at room temperature.

### DETAILED DESCRIPTION

In accordance with the present invention, new combinations of new quaternary ammonium or phosphonium salts provide higher operating voltage and/or greater energy density than the previously known, conventional salts, when the salts are used as electrolytes in electric devices such as capacitors, supercapacitors, electrochemical capacitors, electrolytic capacitors, batteries, fuel cells, sensors, electrochromic devices, photoelectrochemical solar cells, light-emitting electrochemical cells, polymer light emitting diodes (PLEDs), electrophoretic displays, and polymer light-emitting electrochemical cells (PLECs), and, more particularly, electric double-layer capacitors (ELDC), which capacitors are members of the family of supercapacitors, and similar devices containing an electrolyte. In addition, the new combinations of new quaternary ammonium or phosphonium salts may be useful in improving magnesium-ion and/or lithium-ion batteries and electrolytic capacitors.

In one embodiment, the electrolytes contain quaternary ammonium moieties that have a general formula (I), or quaternary phosphonium moieties that have a general formula (II):

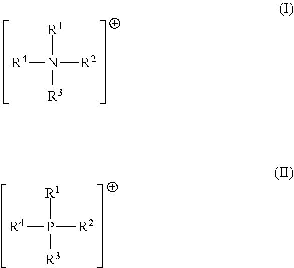

wherein in formulas (I) and (II), R¹, R², R³ and R⁴ are each independently a branched or unbranched alkyl group containing from 1 to about 20 carbon atoms. In one embodiment, in formulas (I) and (II), R¹, R², R³ and R⁴ are each independently a branched or unbranched alkyl group containing from 1 to about 10 carbon atoms. In one embodiment, in formulas (I) and (II), R¹, R², R³ and R⁴ are each independently a branched or unbranched alkyl group containing from 1 to about 6 carbon atoms. Formula (I) may be written as [NR¹R²R³R⁴]⁺, and Formula (II) may be written as [PR¹R²R³R⁴]⁺.

In one embodiment, the electrolytes contain two quaternary ammonium moieties or two quaternary phosphonium moieties, which may be conveniently referred to as a first quaternary ammonium moiety and a second quaternary ammonium moiety, or as a first quaternary phosphonium moiety and a second quaternary phosphonium moiety. The first and second quaternary ammonium or phosphonium moieties are always different from each other.

In one embodiment, the first quaternary ammonium or phosphonium salt contains an ammonium group having a general formula [NR⁵(R⁶)_{3]}⁺, or a phosphonium group having a general formula [PR⁵(R⁶)₃]⁺, wherein R⁵□R⁶, and each R⁵ and R⁶ independently is a branched or unbranched alkyl group containing from 1 to about 20 carbon atoms. In this embodiment, in essence, R⁵═R¹ as defined in the general Formulas (I) and (II), and R⁶═R²═R³═R⁴, as defined in the general Formulas (I) and (II). Each of R⁵ and R⁶ may be independently selected from the above branched or unbranched alkyl group containing from 1 to about 20 carbon atoms, or from 1 to about 10 carbon atoms, or from 1 to about 6 carbon atoms. It is considered more convenient to refer to the R groups of the first quaternary ammonium or phosphonium as R⁵ and R⁶ instead of R¹, R², R³ and R⁴, although the definitions of the R groups of R⁵ and R⁶ are the same as the R groups in the respective first quaternary ammonium or phosphonium.

In one embodiment, the second quaternary ammonium moiety of Formula (I), or the second quaternary phosphonium moiety of Formula (II), R¹═R², R³═R⁴, and R²≠R³. In this embodiment, R¹ and R² are independently selected from the above branched or unbranched alkyl group containing from 1 to about 20 carbon atoms, or from 1 to about 10 carbon atoms, or from 1 to about 6 carbon atoms; and R³ and R⁴ are independently selected from the above branched or unbranched alkyl group containing from 1 to about 20 carbon atoms, or from 1 to about 10 carbon atoms, or from 1 to about 6 carbon atoms, but the alkyl groups in R¹ and R² are different from the alkyl groups in R³═R⁴. That is, in this embodiment, the second quaternary ammonium or phosphonium moiety contains two pair of R groups in which the members of each pair are identical to each other, but the two pairs are different from each other. That is, R¹ and R² are the same, R³ and R⁴ are the same, but R² and R³ are not the same, and R¹ and R⁴ are not the same. An example of this latter embodiment is the moiety dimethyldipropyl quaternary ammonium, in which R¹═R²=methyl, and R³═R⁴=propyl.

In one embodiment, in the second quaternary ammonium or phosphonium moiety, the above branched or unbranched alkyl group containing from 1 to about 20 carbon atoms, or from 1 to about 10 carbon atoms, or from 1 to about 6 carbon atoms may be as follows:

| Onium Ion | R¹ = R² | R³ = R⁴ |
|---|---|---|
| Dimethyldiethyl | Methyl | Ethyl |
| Dimethyldipropyl | Methyl | Propyl |
| Dimethyldibutyl | Methyl | Butyl |
| Dimethyldipentyl | Methyl | Pentyl |
| Dimethyldihexyl | Methyl | Hexyl |
| Dimethyldiheptyl | Methyl | Heptyl |
| Dimethyldioctyl | Methyl | Octyl |
| Diethyldipropyl | Ethyl | Propyl |
| Diethyldibutyl | Ethyl | Butyl |
| Diethyldipentyl | Ethyl | Pentyl |
| Diethyldihexyl | Ethyl | Hexyl |
| Diethyldiheptyl | Ethyl | Heptyl |
| Diethyldioctyl | Ethyl | Octyl |

In selecting an appropriate ammonium or phosphonium ion moiety, the following may be taken into consideration:

cost; especially for use in production of mass produced items; ammonium-ions or phosphonium-containing longer alkyl chains are more expensive;

solubility in the selected solvent; longer alkyl chains can generally dissolve at a higher concentration;

diffusion coefficient; longer alkyl chains have a lower diffusion coefficient, which may slow charging and discharging of the EDLC; and

size; longer alkyl chains make the cation larger, which may decrease the maximum capacity due to steric hindrance of the cations at the active carbon electrode).

In one embodiment, the present salt may include an anion as counterion selected from BF₄⁻, PF₆⁻, AsF₆⁻, SbF₆⁻, BARF, BOB, FOB, BSB, tetrakis(pentafluorophenyl)borate (B(C₆F₅)₄⁻), Al(OC(CF₃)₃)₄, maleate, phthalate, ClO₄⁻, trifluoromethanesulfonate and alkyl trifluoromethanesulfonate.

The anion may be one selected from BF4, PF6, AsF6 and SbF6, to form the salts of quaternary ammonium moieties as defined herein. As used herein, BF4 is shorthand for BF₄⁻, PF6 is shorthand for PF₆⁻, AsF6 is shorthand for AsF₆⁻, and SbF6 is shorthand for SbF₆⁻. In one embodiment, the anion may be perchlorate, ClO₄⁻, trifluoromethanesulfonate and alkyl trifluoromethanesulfonate.

In accordance with another embodiment of the invention, the salts may comprise an anion selected from one of BARF, BOB, BSB or FOB. Each of these anions is defined in the following.

BARF is [B[3,5-(CF₃)₂C₆H₃]₄], which has the following structure:

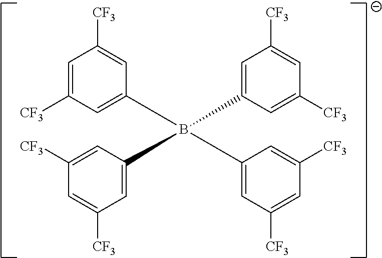

BOB is bis(oxalato)borate, having a structure:

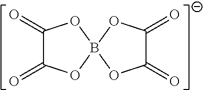

BSB is bis[salicylato(2-)]borate, having a structure:

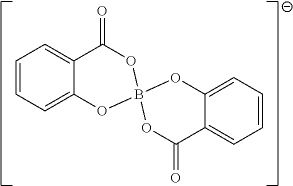

FOB is difluoro(oxalato)borate, having a structure:

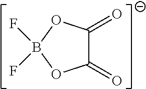

In one embodiment, the anion may be another known anion, for example, tetrakis(pentafluorophenyl)borate (B(C₆F₅)₄⁻) or Al(OC(CF₃)₃)₄⁻.

In another embodiment, the anion may be a polyfluorinated tetraalkylborate [B(RF)₄⁻], or tetraalkylphosphate [P(RF)₆]⁻, in which R═C₁-C₆ branched or unbranched perfluoroalkyl or polyfluoroalkyl in which one or more H remains with the majority of substituents on C being F (i.e. RF═—CF₃, or —CF₂CF₃, or —CHFCF₃, or —CF₂CHFCF₃, etc.).

In one embodiment, the counterion may be a phthalate anion or a maleate anion.

In one embodiment, the solvent in the electrolyte is one or more shown in the following table:

| Solvent | BP. | MP. | Permittivity | Viscosity @25° C. |
|---|---|---|---|---|
| Propylene carbonate | 241° C. | −55° C. | 65 | 2.8 mPa · s |
| Dimethylsulfoxide | 189° C. | 18.5° C. | 29.8 | 1.996 mPa · s |
| N,N dimethylformamide | 153° C. | −61° C. | 30.9 | 0.92 mPa · s |
| Ethylene carbonate | 260° C. | 37° C. | 95 | 1.92 mPa · s (40° C.) |
| Diethyl carbonate | 128° C. | −48° C.- | 3.1 | 0.795 mPa · s |
| Acetonitrile | 82° C. | −45° C. | 38 | 0.369 mPa · s |
| Sulfolane | 285° C. | 26 | 14.8 | 10 mPa · s |
| γ-butyrolactone | 204° C. | −44 | 42 | 1.7 mPa · s |
| dimethyl carbonate | 90° C. | 5° C. | 3.1 | 0.625 mPa s |

Additional solvents that may be useful with the present invention include trimethylene carbonate (TMC, 1,3-dioxan-2-one) and butylene carbonate (BC, 4-ethyl-1,3-dioxolan-2-one).

Any of the foregoing solvents may be used in accordance with the present invention. In one embodiment, the solvent is acetonitrile. In one embodiment, the solvent is diethyl carbonate. In one embodiment, the solvent is propylene carbonate.

The maximum operating voltage of an EDLC is limited by the voltage where the salt in the electrolyte starts to decompose by redox reactions. The decomposition of the electrolyte limits the amount of energy stored in the EDLC and its lifetime. To avoid any shortening of the lifetime the maximum operating voltage of an EDLC is typically 2.5 V. The electrolyte used in commercially available EDLCs generally consists of tetraethylammonium tetrafluoroborate (TEA. BF4) or methyltriethylammonium tetrafluoroborate (MTEA.BF4) dissolved in acetonitrile (ACN) or propylene carbonate (PC). As part of the systematic study to determine the maximum operating voltage of the EDLC MTEA.BF4 is taken as a reference. In addition, a new quaternary ammonium BF4 salt, namely dimethyldipropylammonium tetrafluoroborate (DMDPA.BF4), is studied as follows.

Experimental

### I. Exemplary BF4 Salt Preparation

To a 2L polyethylene reaction vessel is charged 244.12 g of nominally 50 wt % aqueous HBF4 (Aldrich) and a Teflon coated magnetic stirbar. To a 1 L polypropylene flask is charged 511.96 g of nominally 40 wt % dimethyldipropylammonium hydroxide (DMDPOH) (SACHEM, Inc.). Both vessels are sealed and placed in a refrigerator at 5° C. overnight.

The reaction vessel is equipped with a 500 mL glass addition funnel and a Teflon coated thermocouple, and is then sealed and placed in a constant temperature bath regulated at 10° C. The addition funnel is quickly charged to about half capacity with the cold DMDPOH solution; the remainder of the solution is kept in the refrigerator until needed. Dropwise addition of the DMDPOH solution with vigorous magnetic stirring causes a strong exotherm that raises the temperature of the reaction solution to about 15° C. The rate of further addition is adjusted to keep the internal temperature of the reaction solution below 20° C., with the aid of the external cooling bath. More DMDPOH solution is charged to the addition funnel as needed until all of the solution is used.

At the end of the DMDPOH solution addition, the pH of the reaction solution is 4. An additional 5.35 g of DMDPOH solution is added, raising the pH to 5. The reaction solution is then transferred to a PFA addition funnel and extracted four (4) times with 150 mL portions of pure dichloromethane.

The dichloromethane extracts are combined and evaporated to dryness on a rotary evaporator, yielding 252 g of DMDPBF4 (dimethyldipropylammonium tetrafluoroborate) as a pure, white powder (84% recovery of theoretical amount). To further dry the product and remove any traces of dichloromethane, the white powder may be dissolved in isopropyl alcohol (with optional filtering through an inert filter membrane) and evaporated to dryness on a rotary evaporator.

### II. Electrolyte Preparation

Single salt electrolytes and electrolytes with two salts are prepared at various concentrations in anhydrous acetonitrile (<0.001 wt. % H₂O, Sigma Aldrich).

### III. Conductivity

The conductivity of the electrolytes is measured with a HACH HQ30 conductivity meter at room temperature.

### IV. Electrode and EDLC Construction

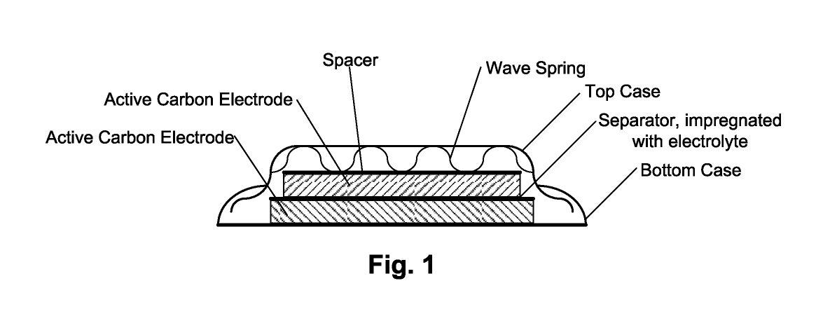

High area active carbon electrodes supported on aluminum foil current collector are prepared using an in-house method. A high precision disk cutter is used to cut out two electrodes per EDLC, one with a diameter of 15 mm and one with a diameter of 19 mm. A polypropylene separator (CELGARD® 2500) disc is cut with a diameter of 20 mm. The EDLCs are prepared by filling CR2032 coin cell cases in a nitrogen-filled glove box. Firstly, the 19 mm electrode with the active carbon layer facing up is placed in the positive coin cell case. Secondly, a few drops of electrolyte are dispensed on top of the active carbon layer. Then, the separator is placed on top of the wetted active carbon layer. Again, a few drops of electrolyte are dispensed on the separator to saturate it with electrolyte. Next, the 15 mm electrode is placed on top of the separator with the active carbon layer facing down. To fill the remaining space and to ensure a good electrical connection to the top coin cell case, a spacer and a wave spring are put on top of the 15 mm electrode. Finally, the coin cell is sealed by applying a pressure of 750 psi using a hydraulic sealing machine. A schematic cross section of the resulting EDLC is shown in FIG. 1.

Electrical Characterization

The electrical characterization carried out is two-fold. First, cyclic voltammetry is performed with a Metrohm AUTOLAB® PGSTAT302N to quickly scan for the maximum voltage where no redox reactions occur. Long term stability tests are performed with a Maccor 4600 battery tester.

Results

I. Conductivity

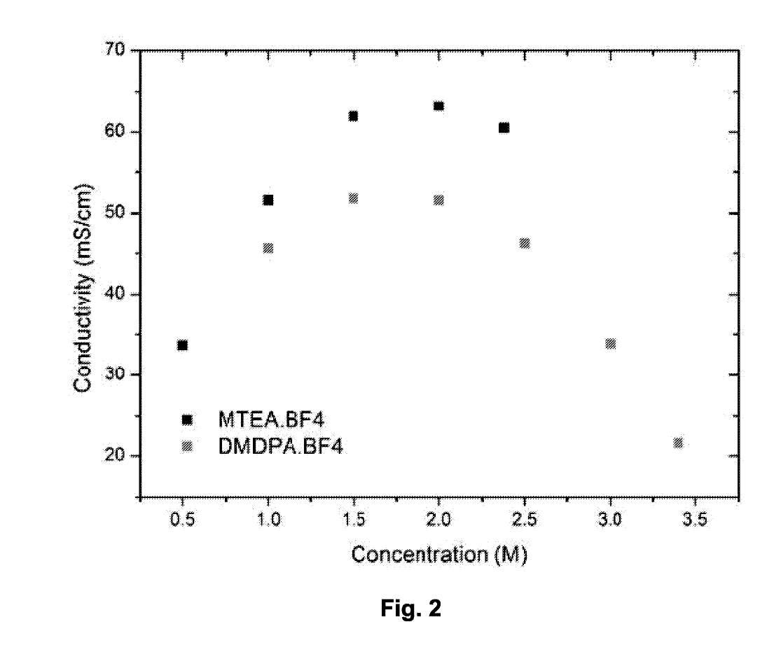

An important property of electrolytes for EDLCs is the conductivity. The higher the conductivity the faster the ions can diffuse to the electrodes to build up the electrical double layers when a voltage is applied and diffuse back into the bulk of the electrolyte when discharging the electrical double layers. In FIG. 2 the conductivity of MTEA.BF4 and DMDPA.BF4 in acetonitrile measured up to their maximum solubility at room temperature is depicted.

From FIG. 2 it can be seen that MTEA.BF4 has a higher conductivity than DMDPA.BF4 throughout the studied concentrations. The maximum conductivity is reached at a concentration of 1.5 M for both BF4 salts. The maximum solubility strongly depends on the cation of the BF4 salt, where DMDPA.BF4 is found to have a much higher solubility than MTEA.BF4. Although the conductivity is in favor of MTEA.BF4, the larger solubility window of DMDPA.BF4 makes it possible to study a wider range of electrolyte concentrations.

II. Maximum Voltage Characterization

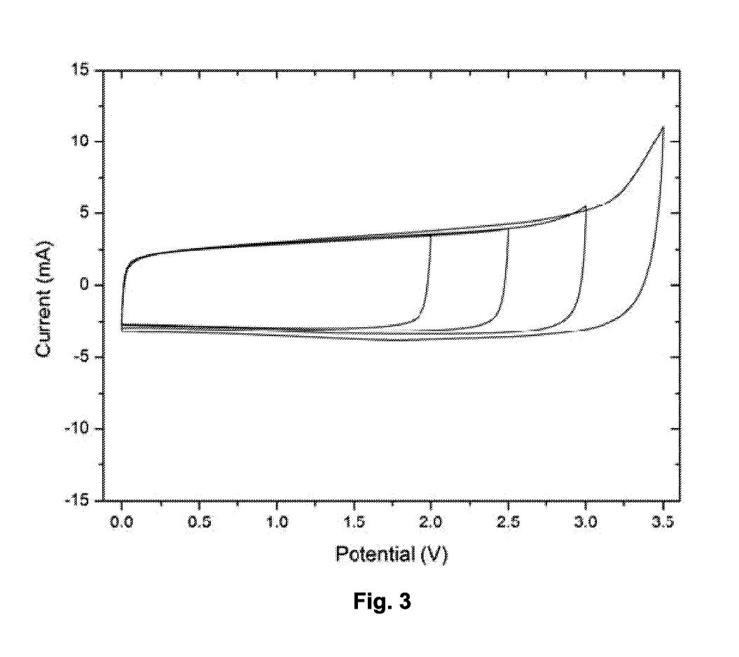

Cyclic voltammetry (CV) is performed to determine the effects of the cation of the BF4 salt and concentration on the maximum operating voltage of the EDLC. CV scans are recorded between 0 to 5 volt in successive steps of 0.5 V at a scan rate of 10 mV/s at room temperature. The ideal behavior of a capacitor is given by

$$C = \frac{{l}^{⋆} t}{V} ,$$

where C is the capacitance, I is the current, t is the time and V is the voltage. To obey this rule, the shape of the voltammogram should therefore be rectangular. When the voltage is scanned to a voltage where the electrolyte is no longer stable and begins to undergo Faradaic or redox reactions, the measured current increases due to the Faradaic reactions. In so-called hybrid capacitors, the pseudo-capacitance due to Faradaic reactions is used to increase the overall capacity of an EDLC. However, it is essential that the Faradaic reactions are reversible and fast. In the present case, the currents resulting from redox reactions are due to the decomposition of the electrolyte and are therefore not preferred as they decrease the lifetime of the EDLC. As an example the voltammograms of 1.50 M MTEA.BF4 in acetonitrile when scanning between 0 and 2.00, 2.50, 3.00 and 3.50 V are depicted in FIG. 3.

The voltammograms obtained by scanning between 0 and 2.0 and 2.5 V overlap almost perfectly. Contrastingly, the voltammogram up to 3.0 V deviates from the rectangular shaped voltammograms, in the voltage range between 2.5 and 3.0 V. Increasing the voltage beyond 3.0 V further increases the deviation from ideal behavior. The voltage of the scan to the highest potential that does not show any Faradaic currents is taken as the maximum operating voltage. Similar analysis is carried out on EDLCs filled with single salt solutions of MTEA.BF4 and DMDPA.BF4 in acetonitrile at concentrations of 1.50 M, 2.25 M and at their maximum solubility. The results are shown in Table 1.

TABLE 1
Maximum operating voltage and capacitance of EDLCs filled with
MTEA.BF4 and DMDPA.BF4 in acetonitrile as a function of
concentration.

| BF4 salt | Concentration (M) | Max. operating V (V) |
|---|---|---|
| MTEA.BF4 | 1.50 | 2.50 |
| MTEA.BF4 | 2.25 | 2.50 |
| MTEA.BF4 | 2.40 | 3.00 |
| DMDPA.BF4 | 1.50 | 2.50 |
| DMDPA.BF4 | 2.25 | 2.50 |
| DMDPA.BF4 | 3.40 | >5.00 |

At 1.50 M MTEA.BF4 the maximum operating voltage is 2.5 V, which is similar to the maximum operating voltage of commercially available EDLCs. Increasing the MTEA.BF4 concentration to 2.25 M does not increase the maximum operating voltage. Further increasing the concentration to the maximum solubility increases the operating voltage to 3.00 V. Similar behavior is found for DMDPA.BF4, where at the maximum concentration of 3.40 M the voltage window is found to be outside of the measurement range. At the highest concentrations of BF4 salt, the CVs are significantly suppressed by the lower conductivity of the electrolyte. As a consequence, the amount of energy that can be stored is reduced.

To overcome the drawback of the lower energy stored in the EDLC at high concentrations, solutions comprised of MTEA.BF4 and DMDPA.BF4 are prepared. The concentration of MTEA.BF4 is fixed at 1.50 M and the DMDPA.BF4 concentration is varied from 0.50 M to 1.00 M. Voltammograms are recorded to assess the maximum operating voltage of the EDLC. The results are listed in Table 2.

TABLE 2
Maximum operating voltage of EDLCs filled with 1.50M MTEA.BF4 and
0.50, 0.75 and 1.00M DMDPA.BF4 in acetonitrile.

| | | | | Max. operating V |
|---|---|---|---|---|
| BF4 salt 1 | Conc. (M) | BF4 salt 2 | Conc. (M) | (V) |
| MTEA.BF4 | 1.50 | DMDPA.BF4 | 0.50 | 2.50 |
| MTEA.BF4 | 1.50 | DMDPA.BF4 | 0.75 | 3.00 |
| MTEA.BF4 | 1.50 | DMDPA.BF4 | 1.00 | 3.00 |

Surprisingly, adding 0.50 M DMDPA.BF4 to 1.50 M MTEA.BF4 does not increase the maximum operating voltage. Surprisingly, increasing the DMDPA.BF4 concentration to 0.75 M increases the maximum operating voltage to 3.00 V. Contrastingly, the maximum operating voltage of 2.25 M MTEA.BF4 and 2.25 M DMDPA.BF4 (see Table 1) did not increase. Therefore, the combination of MTEA.BF4 and DMDPA.BF4 is responsible for the improved voltage window. Further increase of the DMDPA.BF4 to 1.00 M does not lead to a higher operating voltage.

III. Maximum Voltage, Capacitance and Energy Characterization

The data from the CV experiments is used as an indication of the maximum voltage where no electrolyte decomposition occurs. The next step is to study the long term stability by subsequently applying a voltage of 1.75 to 3.50 V in steps of 0.25 V for 24 hrs. and measure the capacitance by galvanostatic charging and discharging at a current of 0.5 mA. The resulting maximum operating voltage, capacitance and energy are listed in Table 3.

TABLE 3
Maximum operating voltage and capacitance of EDLCs filled with 1.50M
MTEA.BF4, 1.50M DMDPA.BF4 and 1.50M MTEA.BF4 with varying
concentrations of DMDPA.BF4 in ACN.

| | | | | Max. | | |
|---|---|---|---|---|---|---|
| | Conc. | | | operating | Capacitance | Energy |
| BF4 salt 1 | (M) | BF4 salt 2 | Conc. (M) | V (V) | (F) | (J) |
| MTEA.BF4 | 1.50 | N/A | N/A | 2.50 | 0.30 | 0.94 |
| DMDPA.BF4 | 1.50 | N/A | N/A | 2.50 | 0.30 | 0.94 |
| MTEA.BF4 | 1.50 | DMDPA.BF4 | 0.50 | 2.75 | 0.30 | 1.13 |
| MTEA.BF4 | 1.50 | DMDPA.BF4 | 0.75 | 3.00 | 0.30 | 1.35 |
| MTEA.BF4 | 1.50 | DMDPA.BF4 | 1.00 | 3.00 | 0.30 | 1.35 |

Single salt electrolytes of 1.50 M MTEA.BF4 and DMDPA.BF4 show a maximum operating voltage of 2.5 V. Increasing the voltage beyond 2.50 V significantly decreases the capacitance and consequently the amount of energy stored in the EDLC. Adding 0.50 M DMDPA.BF4 to 1.5 M MTEA.BF4 increases the maximum voltage to 2.75 V. Further increase of the DMDPA.BF4 concentration to 0.75 M improves the voltage to 3.0 V. Adding 1.00 M DMDPA.BF4 does not change the maximum operating voltage. At low charging and discharging currents the calculated capacitance is found to be independent of the electrolyte mixture. The amount of energy stored in the EDLC increases from the reference value of 0.94 J to 1.35 J for 1.50 M MTEA.BF4 with 0.75 M DMDPA.BF4.

It should be appreciated that the process steps and compositions described herein may not form a complete system or process flow for making an electrical device that would employ the disclosed compositions, such as might be carried out in actual practice. The present invention can be practiced in conjunction with synthetic organic and device manufacturing techniques and apparatus currently used in the art, and only so much of the commonly practiced materials, apparatus and process steps are included as are necessary for an understanding of the present invention.

While the principles of the invention have been explained in relation to certain particular embodiments, and are provided for purposes of illustration, it is to be understood that various modifications thereof will become apparent to those skilled in the art upon reading the specification. Therefore, it is to be understood that the invention disclosed herein is intended to cover such modifications as fall within the scope of the appended claims. The scope of the invention is limited only by the scope of the claims.

1. An electric device, comprising an electrolyte comprising:
a solvent;
a first quaternary ammonium or phosphonium salt; and
a second quaternary ammonium or phosphonium salt, containing an ammonium group having a general formula [NR¹R²R³R⁴]⁺, or a phosphonium group having a general formula [PR¹R²R³R⁴]⁺, wherein R¹═R², R³═R⁴, R²≠R³, and each R¹, R², R³ and R⁴ independently is a branched or unbranched alkyl group containing from 1 to about 20 carbon atoms, and
wherein each salt comprises an anion, and wherein the first and second ammonium or phosphonium are not the same.

2. The electric device of claim 1 wherein the first quaternary ammonium or phosphonium salt contains an ammonium group having a general formula [NR⁵(R⁶)3]⁺, or a phosphonium group having a general formula [PR⁵(R⁶)₃]⁺, wherein R⁵≠R⁶, and each R⁵ and R⁶ independently is a branched or unbranched alkyl group containing from 1 to about 20 carbon atoms.

3. The electric device of claim 1 wherein the anion comprises one or a combination of two or more of BF₄⁻, PF₆⁻, AsF₆⁻, SbF₆⁻, BARF, BOB, FOB, BSB, tetrakis(pentafluorophenyl)borate (B(C₆F₅)₄⁻), Al(OC(CF₃)₃)₄⁻, maleate, phthalate, ClO₄⁻, trifluoromethanesulfonate and alkyl trifluoromethanesulfonate.

4. The electric device of claim 1 wherein the first quaternary ammonium salt is methyltriethyl ammonium BF4 (MTEABF4) and the second quaternary ammonium salt is dimethyldipropyl ammonium BF4 (DMDPABF4).

5. The electric device of claim 4 wherein the DMDPABF4 is at a concentration in the range from about 0.5 M to about 1.0 M, and the MTEABF4 is at a concentration in the range from about 1 M to about 2 M, or the DMDPABF4 is at a concentration in the range from about 0.65 M to about 0.85 M, and the MTEABF4 is at a concentration in the range from about 1.25 M to about 1.75 M, or the DMDPABF4 is at a concentration of about 0.75 M, and the MTEABF4 is at a concentration of about 1.5 M.

6. The electric device of claim 1 wherein the ammonium or phosphonium of the second quaternary ammonium or phosphonium salt is one or a combination of any two or more of dimethyldiethyl, dimethyldipropyl, dimethyldibutyl, dimethyldipentyl, dimethyldihexyl, diethyldipropyl, diethyldibutyl, diethyldipentyl and diethyldihexyl ammonium or phosphonium.

7. The electric device of claim 1 wherein the solvent is selected from propylene carbonate, dimethylsulfoxide, N, N dimethylformamide, ethylene carbonate, dimethyl carbonate, diethyl carbonate, acetonitrile, sulfolane and y-butyrolactone.

8. The electric device of claim 1 wherein the electric device is a capacitor, supercapacitor, electrochemical capacitor, electrolytic capacitor, battery, fuel cell, sensor, electrochromic device, photoelectrochemical solar cell, light-emitting electrochemical cell, polymer light emitting diode (PLED), electrophoretic display, polymer light-emitting electrochemical cell (PLEC), a magnesium-ion battery, a lithium-ion battery, an electrolytic capacitor, or an electric double-layer capacitor (ELDC).

9. The electric device of claim 1 wherein the electric device is an electric double layer capacitor (ELDC).

10. An electrolyte comprising:
a solvent;
a first quaternary ammonium or phosphonium salt; and
a second quaternary ammonium or phosphonium salt, containing an ammonium group having a general formula [NR¹R²R³R⁴]⁺, or a phosphonium group having a general formula [PR¹R²R³R⁴]⁺, wherein R¹═R², R³═R⁴, R²≠R³, and each R¹, R², R³ and R⁴ independently is a branched or unbranched alkyl group containing from 1 to about 20 carbon atoms, and
wherein each salt comprises an anion, and wherein the first and second ammonium or phosphonium are not the same.

11. The electrolyte of claim 10 wherein the first quaternary ammonium or phosphonium salt contains an ammonium group having a general formula [NR⁵(R⁶)_{3]}⁺, or a phosphonium group having a general formula [PR⁵(R⁶)₃]⁺, wherein R⁵≠R⁶, and each R⁵ and R⁶ independently is a branched or unbranched alkyl group containing from 1 to about 20 carbon atoms.

12. The electrolyte of either of claim 10 wherein the comprises one or a combination of two or more of BF₄⁻, PF₆⁻, AsF₆⁻, SbF_{6hu -}, BARF, BOB, FOB, BSB, tetrakis(pentafluorophenyl)borate (B(C₆F₅)₄⁻), Al(OC(CF₃)₃)₄⁻ maleate, phthalate, ClO₄⁻, trifluoromethanesulfonate and alkyl trifluoromethanesulfonate.

13. The electrolyte of claim 10 wherein the first quaternary ammonium salt is methyltriethyl ammonium BF4 (MTEABF4) and the second quaternary ammonium salt is dimethyldipropyl ammonium BF4 (DMDPABF4).

14. The electrolyte of claim 13 wherein the DMDPABF4 is at a concentration in the range from about 0.5 M to about 1.0 M, and the MTEABF4 is at a concentration in the range from about 1 M to about 2 M, or the DMDPABF4 is at a concentration in the range from about 0.65 M to about 0.85 M, and the MTEABF4 is at a concentration in the range from about 1.25 M to about 1.75 M, or the DMDPABF4 is at a concentration of about 0.75 M, and the MTEABF4 is at a concentration of about 1.5 M.

15. The electrolyte of claim 10 wherein the ammonium ion of the second quaternary ammonium salt is one or a combination of any two or more of dimethyldiethyl, dimethyldipropyl, dimethyldibutyl, dimethyldipentyl, dimethyldihexyl, diethyldipropyl, diethyldibutyl, diethyldipentyl and diethyldihexyl ammonium.

16. The electrolyte of claim 10 wherein the solvent is selected from propylene carbonate, dimethylsulfoxide, N, N dimethylformamide, ethylene carbonate, dimethyl carbonate, diethyl carbonate, acetonitrile, sulfolane and γ-butyrolactone.

17. The electric device of claim 2 wherein the anion comprises one or a combination of two or more of BF₄⁻, PF₆⁻, AsF₆⁻, SbF₆⁻, BARF, BOB, FOB, BSB, tetrakis(pentafluorophenyl)borate (B(C₆F₅)₄⁻), Al(OC(CF₃)₃)₄⁻, maleate, phthalate, ClO₄⁻, trifluoromethanesulfonate and alkyl trifluoromethanesulfonate.

18. The electrolyte of claim 11 wherein the anion comprises one or a combination of two or more of BF₄⁻, PF₆⁻, AsF₆⁻, SbF₆⁻, BARF, BOB, FOB, BSB, tetrakis(pentafluorophenyl)borate (B(C₆F₅)₄⁻), Al(OC(CF₃)₃)₄⁻, maleate, phthalate, Clo₄⁻, trifluoromethanesulfonate and alkyl trifluoromethanesulfonate.
